(19) United States
(12) Patent Application Publication
(10) Pub. No.: US 2026/0006123 A1
(43) Pub. Date: Jan. 1, 2026

(54) SYSTEM AND METHOD FOR DETERMINING LIKELIHOOD OF PHONE NUMBERS BEING USED FRAUDULENTLY BASED ON INTELLIGENCE DERIVED FROM QUERIES RELATED TO ACTIVITIES INVOLVING THE PHONE NUMBERS

(71) Applicant: Zumigo, Inc., San Jose, CA (US)

(72) Inventors: Venkatarama S. PARIMI, Dublin, CA (US); Harish MANEPALLI, San Jose, CA (US); Chirag C. BAKSHI, San Jose, CA (US); Oppilamani SUDHANDIRAN, Fremont, CA (US); Ziba DERAFSHI, San Carlos, CA (US); Saravanan JAGADHESON, Fremont, CA (US)

(21) Appl. No.: 18/755,533

(22) Filed: Jun. 26, 2024

(51) Int. Cl. H04M 3/22

(52) U.S. Cl. CPC H04M 3/2281

(57) ABSTRACT

A computer includes a processor that determines fraud risk levels for phone numbers, by performing the steps of: continually monitoring a network connection for queries received from computers of a plurality of organizations, wherein each of the queries includes a phone number; for each query received, extracting and storing the phone number; for each phone number, determining a likelihood that the phone number has been used fraudulently, based at least on one of: (1) a frequency of the phone number being included in the queries, and (2) a number of different organizations that sent queries including the phone number; and determining a fraud risk level for each phone number based at least on the determined likelihood that the phone number has been used fraudulently, and transmitting a notification to one or more organizations when the fraud risk level of any of the phone numbers exceeds a threshold fraud risk.

### BACKGROUND OF THE INVENTION

It is common practice for organizations such as banks and electronic commerce (e-commerce) companies to use phone numbers such as mobile directory numbers (MDNs) for authenticating (verifying the identity of) users of their products and services. Such practice authenticates a user based on a possession factor (possession of a device such as a smartphone on which a phone number has been activated). For example, an organization may require a person to provide a phone number as a mandatory step for signing up for an account with the organization. The organization may then perform one or more authentication steps requiring an input of the phone number before registering the account. As another example, after signup, the organization may perform one or more authentication steps requiring an input of a user's phone number each time the user attempts to sign in to the account and/or each time the user attempts to perform a transaction using the account such as to withdraw or send money or to purchase a product.

One example of such authenticating is to send a one-time passcode (OTP) to the phone number via a text message or phone call and to then wait for a response identifying the OTP. However, it is unsafe for an organization to blindly send an OTP to a phone number because the phone number could have been compromised by a fraudster. For example, the fraudster may have convinced a service agent of another person's mobile operator to activate the other person's phone number on a subscriber identity module (SIM) card of the fraudster's device, commonly known as SIM hijacking or SIM kidnapping. As a result, blindly sending an OTP to the phone number could result in providing the OTP to the fraudster's device. The fraudster could then use the OTP to create an account impersonating the other person or, if the other person already has an account, sign in to the other person's account to perform a fraudulent transaction. Accordingly, there is a need to more accurately identify phone numbers that are being used fraudulently.

### SUMMARY OF THE INVENTION

One or more embodiments provide a computer including a processor and memory, wherein the processor executes instructions stored in the memory to determine fraud risk levels for phone numbers. The processor performs the steps of: continually monitoring a network connection for queries received from computers of a plurality of organizations, wherein each of the queries includes a phone number; for each query received, extracting the phone number included in the query and storing the phone number extracted from the query in association with an identifier (ID) of an organization from which the query was received; for each phone number extracted from the queries, determining a likelihood that the phone number has been used fraudulently, based at least on one of: (1) a frequency of the phone number being included in the queries, and (2) a number of different organizations that sent queries including the phone number; and determining a fraud risk level for each phone number extracted from the queries based at least on the determined likelihood that the phone number has been used fraudulently, and transmitting a notification to one or more organizations when the fraud risk level of any of the phone numbers exceeds a threshold fraud risk.

Further embodiments include a method comprising the above steps and a non-transitory computer-readable storage medium comprising instructions that cause a computer to carry out the above steps.

### BRIEF DESCRIPTION OF THE DRAWINGS

FIG. 1 is a block diagram of a computer system in which embodiments may be implemented.

FIG. 2 is a flow diagram of a method that may be performed by a host computer to continually monitor one or more network connections for queries and feedback messages received from computers of organizations, according to some embodiments.

FIG. 3 is a flow diagram of a method that may be performed by the host computer to train a machine-learning model to make predictions about the fraudulent use of phone numbers, according to some embodiments.

FIG. 4 is a flow diagram of a method that may be performed by the host computer to train a machine-learning model to help make predictions about the fraudulent use of phone numbers, according to some embodiments.

FIG. 5 is a flow diagram of a method that may be performed by the host computer and the computers of the organizations, to identify and respond to the fraudulent use of phone numbers, according to some embodiments.

### DETAILED DESCRIPTION

Techniques for identifying the fraudulent use of phone numbers are described. According to some embodiments, computers of a plurality of organizations are monitored by a host computer. As requests are transmitted to the organizations such as to create accounts, log in to accounts, and make transactions using the accounts, the computers of the organizations generate queries and transmit the queries to the host computer. Each query includes a phone number associated with a request transmitted to an organization. Each query also requests information about the phone number such as an indication of whether a SIM hijacking has occurred for the phone number.

Techniques described herein determine the likelihood that a phone number has been used fraudulently based on one or both of “velocity” and “popularity.” As used herein, the velocity of a phone number is a frequency at which queries that include the phone number, are received by the host computer. As used herein, the popularity of a phone number is a quantity of different organizations that have transmitted queries that include the phone number, to the host computer. The velocity and popularity of a phone number are examples of intelligence that the host computer derives from queries to detect fraudulent behavior. According to some embodiments, the velocity and/or popularity are inputted to a machine-learning (ML) model such as an artificial neural network (ANN), which is trained to make predictions that aid in determining the likelihood of a phone number being used fraudulently.

Various examples of ML models are contemplated for use by embodiments. As just one of such examples, an ANN may be trained that takes one or both of the velocity and popularity of a phone number as an input, possibly along with other inputs, and that outputs the likelihood of that phone number being used fraudulently. As another one of such examples, an ML model may be trained that similarly takes one or both of the velocity and popularity of a phone number as an input, possibly along with other inputs, in response to which the ML model assigns the phone number to a cluster. Such cluster assignment may then be used to determine the likelihood of fraudulent use.

If it is determined, based at least on one or both of the velocity and popularity of a phone number, that a fraud risk level for the phone number is sufficiently high, the host computer transmits a warning message to all the organizations that queried the host computer about that phone number. Computers at the organizations then prevent fraudulent behaviors, e.g., by refusing to create accounts for fraudsters, by blocking fraudsters from logging in to other users' accounts, and by preventing fraudsters from performing transactions in the other users' accounts. Accordingly, the techniques protect such organizations and users thereof from fraudulent activity based on intelligence derived from the queries. Furthermore, the techniques detect fraudulent activities that may not be detected by conventional fraud-detection techniques, and also detect such fraudulent activities more quickly than conventional techniques in certain situations.

For example, a conventional technique for detecting fraudulent activity may rely on acquiring information from a cellular provider for the phone number indicative of suspicious behavior such as a recent SIM hijacking. However, there may have been no such suspicious behavior despite there being fraudulent activity, e.g., because a fraudster is attempting to access another person's account(s) without otherwise compromising the other person's phone number. Additionally, even if there has been such suspicious behavior, the behavior may not be detectable by conventional techniques, e.g., because the cellular provider does not support providing information indicative of SIM hijacking. Additionally, even if such information is available, techniques described herein may detect fraudulent activities more quickly than conventional techniques, perhaps even before any organization has specifically inquired about an exact type of suspicious behavior that has occurred. These and further aspects of the invention are discussed below with respect to the drawings.

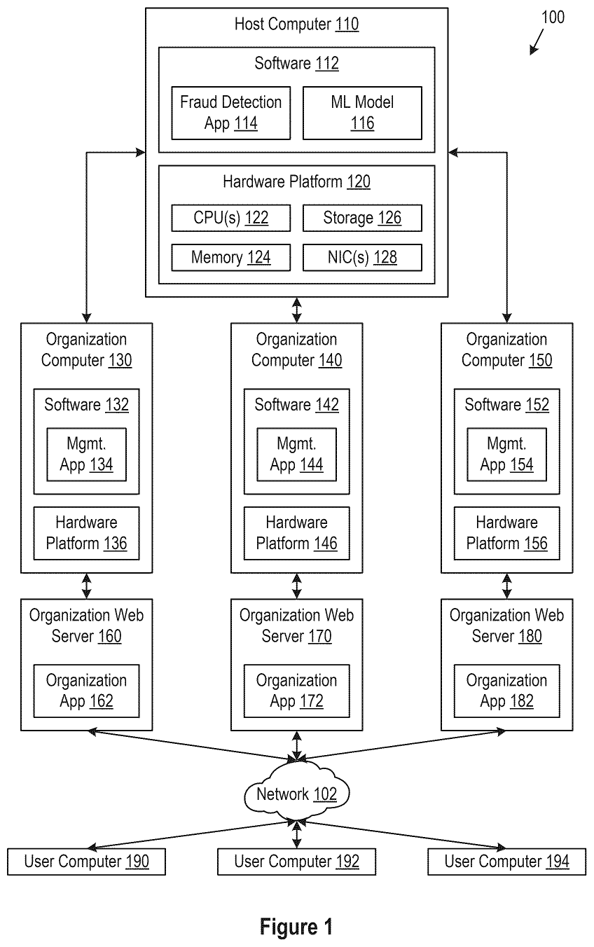

FIG. 1 is a block diagram of a computer system 100 in which embodiments may be implemented. Computer system 100 includes a host computer 110, organization computers 130, 140, and 150, organization web servers 160, 170, and 180, and user computers 190, 192, and 194. Host computer 110 centrally monitors activity at a plurality of organizations for fraudulent use of phone numbers, based on queries received from organization computers 130, 140, and 150. Organization computers 130, 140, and 150 prepare the queries based on web activity at organization web servers 160, 170, and 180, respectively. User computers 190, 192, and 194 access organization web servers 160, 170, and 180 via a network 102. Host computer 110 may monitor activity at more organization computers than those illustrated, and computer system 100 may similarly include more organization web servers and user computers than those illustrated.

Host computer 110 may be, for example, a server computer. Host computer 110 is constructed on a hardware platform 120 such as an x86 architecture platform. Hardware platform 120 includes components of a computer, such as one or more central processing units (CPUs) 122, memory 124 such as random-access memory (RAM), local storage 126 such as one or more magnetic drives or solid-state drives (SSDs), and one or more network interface cards (NICs) 128. CPU(s) 122 are configured to execute instructions such as executable instructions that perform one or more operations described herein, which may be stored in memory 124. NIC(s) 128 enable host computer 110 to communicate with other devices such as organization computers 130, 140, and 150 over a network such as a wide area network (WAN).

Hardware platform 120 supports software 112 such as a fraud detection application 114 and an ML model 116. Fraud detection application 114 is software that uses ML model 116 to analyze queries received from organization computers 130, 140, and 150 to detect fraudulent use of phone numbers such as MDNs. ML model 116 is software such as an ANN trained to analyze data from the queries to make predictions about the fraudulent use of the phone numbers. Although fraud detection application 114 is illustrated as a standalone application, fraud detection application 114 may also be implemented in other configurations. For example, fraud detection application 114 may be implemented in one or more virtualized computing instances. A virtualized computing instance is an addressable data compute node (DCN) or isolated user space instance, such as a virtual machine (VM) or container.

The queries received from organization computers 130, 140, and 150 may be, for example, application programming interface (API) calls made using one or more APIs of host computer 110. Each API call includes a phone number that a respective organization computer requests information about. As one example, a query may request an indication of suspicious activity involving SIM cards, including (1) whether the phone number has been transferred between SIM cards, or (2) whether the phone number was transferred between the SIM cards recently, e.g., less than a predetermined amount of time before the query was received by host computer 110. As another example, a query may request an indication of whether the phone number is receiving cellular services from a suspicious cellular account such as (1) a pre-paid account or (2) an account that was activated for providing cellular services for the phone number recently.

As another example, a query may request an indication of (1) whether a call-forwarding feature has been applied by a cellular provider to the phone number, or (2) whether such a call-forwarding feature was applied recently. As another example, a query may request an indication of whether (1) a phone number was previously deactivated by a cellular provider, or (2) whether such deactivation occurred recently. As another example, a query may request an indication of whether (1) a phone number has been ported between different cellular providers, or (2) whether such porting occurred recently. As another example, a query may (1) request a name and/or address of a person associated with a cellular account for the phone number, or (2) include a name and/or address associated with an account with a requesting organization and request an indication of whether such name and/or address matches a corresponding name and/or address for the person associated with the cellular account.

According to some embodiments, fraud detection application 114 analyzes such queries using ML model 116 to determine whether a phone number has likely been used fraudulently, e.g., to request to open an account, request to log in to an account, or request to make a transaction using an account. ML model 116 predicts or helps predict such likelihood based at least on one of (1) the velocity in which the phone number has been included in queries received by host computer 110 and (2) the popularity of the phone number being included in queries from different organization computers. For example, if host computer 110 frequently (e.g., every fifteen minutes) receives a query including the same phone number, it may be indicative that the phone number is being used fraudulently. As another example, if host computer 110 receives queries from several different organization computers including the same phone number, it may also be indicative that the phone number is being used fraudulently.

Organization computers 130, 140, and 150 are computers such as server computers used by organizations. For example, organization computer 130 may be a server used by a first bank, organization computer 140 may be a server used by a second bank, and organization computer 150 may be a server used by an e-commerce company. Organizations computers 130, 140, and 150 are constructed on hardware platforms 136, 146, and 156, respectively, such as x86 architecture platforms. Hardware platforms 136, 146, and 156 each includes the components of a computer described above for hardware platform 120, such as a CPU(s), memory, local storage, and a NIC(s). In each of hardware platforms 136, 146, and 156, the CPU(s) are configured to execute instructions such as executable instructions that perform one or more operations described herein, which may be stored in the memory. Additionally, the NICs enable each organization computer to communicate with other devices such as host computer 110 and a corresponding organization web server over a network such as a WAN.

Hardware platforms 136, 146, and 156 support software 132, 142, and 152, respectively, including management applications 134, 144, and 154. Management applications 134, 144, and 154 are software that prepare queries for host computer 110 based on activity observed at respective organization web servers. For example, if a login request for an account is received by organization web server 160, management application 134 may prepare a query that requests whether a phone number associated with the account has been transferred between SIM cards, and organization computer 130 transmits the query to host computer 110, e.g., as an API call. Management applications 144 and 154 similarly prepare queries based on activity at organization web servers 170 and 180, respectively, and transmit the queries to host computer 110.

Organization web servers 160, 170, and 180 are server computers used by organizations. Organization web servers 160, 170, and 180 include software such as organization applications 162, 172, and 182, respectively. Organization applications 162, 172, and 182 are software that provide user interfaces (UIs) such as graphical user interfaces (GUIs) through which users access, e.g., goods and services. For example, organization application 162 may be a software platform for the first bank, organization application 172 may be a software platform for the second bank, and organization application 182 may be a software platform for the e-commerce company. Organization applications 162, 172, and 182 receive requests for respective organizations such as to create accounts, sign in to accounts, and perform transactions using accounts.

User computers 190, 192, and 194 are each, for example, a smartphone, a tablet computer, a laptop, or a desktop computer used for accessing one or more organization applications. Any of user computers 190, 192, and 194 may be a computer used by a legitimate user of one or more of such organization applications. On the other hand, any of user computers 190, 192, and 194 may be a fraudster that is attempting to perform fraudulent transactions using one or more of such organization applications. User computers 190, 192, and 194 access the organization applications by connecting to a network 102 such as a WAN.

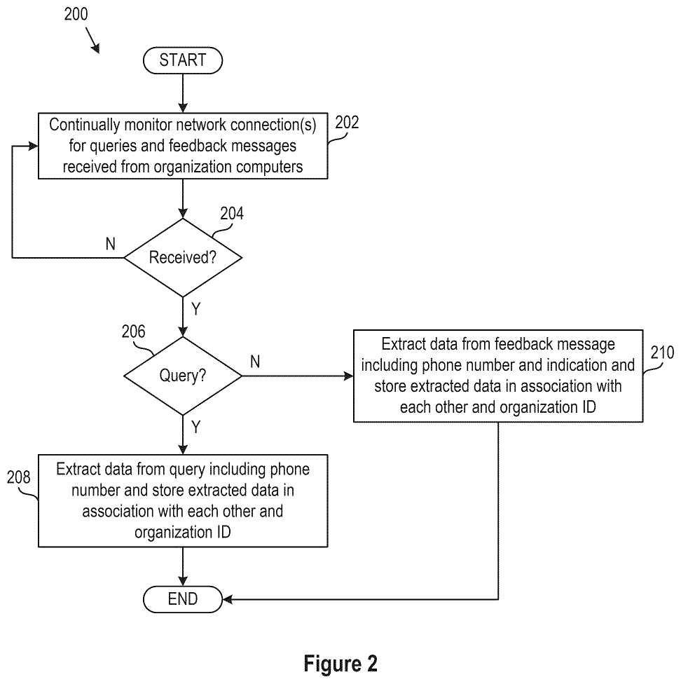

FIG. 2 is a flow diagram of a method 200 that may be performed by host computer 110 to continually monitor one or more network connections for queries and feedback messages received from organization computers such as organization computers 130, 140, and 150, according to some embodiments. At step 202, host computer 110 continually monitors a network connection(s) such as a WAN connection between host computer 110 and organization computer 130, between host computer 110 and organization computer 140, and between host computer 110 and organization computer 150. Host computer 110 monitors the network connection(s) for queries and feedback messages received from the organization computers. At step 204, if host computer 110 has not received a query and has not received a feedback message, method 200 returns to step 202, and host computer 110 continues to monitor the network connection(s) for queries and feedback messages. Otherwise, if host computer 110 has received a query or feedback message from an organization computer such as organization computer 130, method 200 moves to step 206.

At step 206, if host computer 110 has received a query, method 200 moves to step 208. At step 208, host computer 110 extracts data from the query, including a phone number and optionally other data such as a type of the query identifying what information the query requests about the phone number, a calendar date or time of day that the query was transmitted by the organization computer, a type of the organization such as a bank or e-commerce company, an email address associated with the phone number, an internet protocol (IP) address associated with the phone number, etc. Host computer 110 stores the extracted data in association with each other and with an organization ID such as a name of the organization from which the query was received. Host computer 110 may extract the organization ID from the query or may determine the organization ID, e.g., based on a source IP address of the query. For example, host computer 110 may store the extracted data and organization ID in memory 124 and/or storage 126. After step 208, method 200 ends.

Returning to step 206, if host computer 110 has not received a query, i.e., if host computer 110 has received a feedback message from an organization computer such as organization computer 130, method 200 moves to step 210. At step 210, host computer 110 extracts data from the feedback message, including a phone number, an indication of whether the phone number has been used fraudulently, and optionally other data such as those discussed above with respect to queries. Host computer 110 stores the extracted data in association with each other and an organization ID such as a name of the organization. Host computer 110 may extract the organization ID from the feedback message or may determine the organization ID, e.g., based on a source IP address of the feedback message. For example, host computer 110 may store the extracted data and organization ID in memory 124 and/or storage 126. After step 210, method 200 ends. Host computer 110 may perform method 200 repeatedly to continuously receive queries and feedback messages and store data thereof.

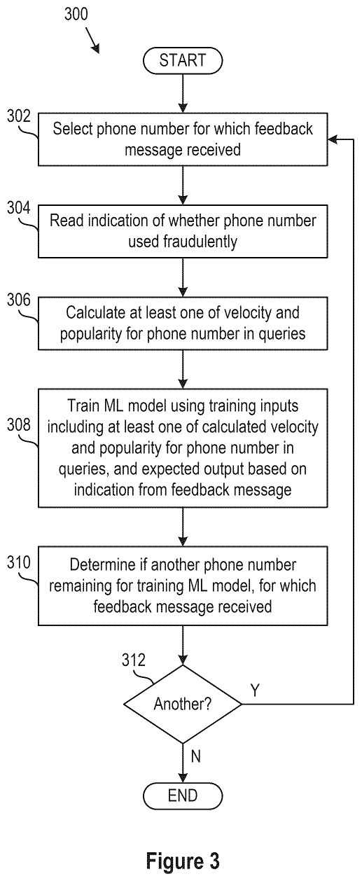

FIG. 3 is a flow diagram of a method 300 that may be performed by host computer 110 to train ML model 116 to make predictions about the fraudulent use of phone numbers, according to some embodiments. Method 300 will be discussed as an example of implementing ML model 116 as an ANN and training ML model 116 through supervised training. However, different implementations of ML model 116 are envisioned for other embodiments, including different implementations of ANNs and different methods for training ML model 116. At step 302, host computer 110 selects a phone number for which a feedback message has been received from an organization computer such as organization computer 130. At step 304, host computer 110 reads an indication of whether the phone number has been used fraudulently, which was previously included in the feedback message. Host computer 110 may read the indication from one of memory 124 and storage 126, depending on where host computer 110 previously stored the indication.

At step 306, host computer 110 calculates at least one of a velocity and popularity for the phone number in queries received from organization computers including organization computers 130, 140, and 150. For example, host computer 110 may read from memory 124 or storage 126 and calculate the number of times host computer 110 received a query including the phone number over a predetermined amount of time. If the predetermined amount of time is, e.g., 1 day, and host computer 110 finds stored information in memory 124 or storage 126 indicating that host computer 110 has received 20 queries including the phone number in the past day, then host computer 110 determines the velocity to be, e.g., 20 queries in 1 day. Additionally, or alternatively, for example, host computer 110 may read from memory 124 or storage 126 and calculate the number of different organizations from which queries have been received that include the phone number. If host computer 110 finds stored information in memory 124 or storage 126 indicating that host computer 110 has received such queries from organization computers of 5 different organizations, then host computer 110 determines the popularity to be, e.g., 5 organizations. Although the calculation of step 306 is illustrated as being performed after step 304, such calculation may be performed at another time. For example, each time a query is received including a phone number, the velocity and popularity for that phone number may be calculated (or recalculated) immediately.

At step 308, host computer 110 trains ML model 116 using training inputs including at least one of the calculated velocity and popularity for the phone number in queries. If host computer 110 is training ML model 116 to determine fraudulent activity based on velocity, host computer 110 uses training inputs including the calculated velocity. Additionally, or alternatively, if host computer 110 is training ML model 116 to determine fraudulent activity based on popularity, host computer 110 uses training inputs including the calculated popularity. ML model 116 may also include additional training inputs such as, for example, the type(s) of queries that included the phone number, calendar dates or times of day that queries including the phone number were transmitted by organization computers, the types of the organizations from which the queries were received, and a reputation of an email or IP address associated with the phone number. ML model 116 may determine the reputation of the email or IP address by querying a reputation service about the email or IP address. For training inputs such as the type(s) of queries, types of organizations, and reputations, host computer 110 may convert the training inputs into values such as 0 for an IP address reputation input for a positive reputation and 1 for a negative reputation.

The training by host computer 110 further uses an expected output based on the indication from the feedback message. Host computer 110 may convert such expected output into a value such as 1 if the indication is that the phone number has been used normally (not fraudulently) or 2 if the indication is that the phone number has been used fraudulently. For example, ML model 116 may generate an output based on the training inputs and then compare the generated output to the expected output. Then, for example, if generated output is deemed incorrect, ML model 116 may backpropagate the error throughout nodes of ML model 116 to update internal parameters (e.g., weights) thereof to improve the accuracy of future predictions of whether a phone number has been used fraudulently. Such updating shifts future generated outputs based on similar inputs, toward correctly predicting a high likelihood of fraudulent activity (if the indication was fraudulent use of the phone number) or a low likelihood of fraudulent activity (if the indication was normal use of the phone number).

For example, the generated output of ML model 116 may be a value such as a percentage chance that the phone number has been used fraudulently. Then, for example, if the generated value is greater than or equal to a threshold value, host computer 110 may determine that it is likely that the phone number has been used fraudulently, and if less than a threshold value, host computer 110 may determine that it is not likely that the phone number has been used fraudulently. As another example, the generated output of ML model 116 may be a category such as “low,” “medium,” “high,” or “very high.” Then, for example, if the generated category is greater than or at a threshold category such as by being at least in the “medium” category,” host computer 110 may determine that it is likely that the phone number has been used fraudulently, and if less than a threshold category such as by being in the “low” category, host computer 110 may determine that it is not likely that the phone number has been used fraudulently.

For example, if the indication is that the phone number was used fraudulently, then ML model 116 may deem a correct generated output to be a generated value that is greater than or equal to the threshold value or a generated category that is greater than or at the threshold category. ML model 116 may deem an incorrect generated output to be a generated value that is less than the threshold value or a generated category that is less than the threshold category, resulting in backpropagation of an error to adjust the parameters. On the other hand, for example, if the indication is that the phone number was used normally, then ML model 116 may deem a correct generated output to be a generated value that is less than the threshold value or a generated category that is less than the threshold category. ML model 116 may deem an incorrect generated output to be a generated value that is greater than or equal to the threshold value or a generated category that is greater than or at the threshold category, resulting in backpropagation of an error to adjust the parameters.

At step 310, host computer 110 determines whether there is another phone number remaining for training ML model 116, for which a feedback message has been received from one of the organization computers. At step 312, if there is another of such phone numbers, method 300 returns to step 302, and host computer 110 selects the phone number for further training ML model 116. Otherwise, if there are no more of such phone numbers, method 300 ends. After performing method 300, host computer 110 may continuously train ML model 116 based on new feedback messages received. For example, host compute 110 may repeat steps 302 to 308 each time a new feedback message is received from an organization computer. Alternatively, for example, host computer 110 may periodically retrain ML model 116 by performing steps 302 to 308, e.g., every hour, based on batches of new feedback messages received from organization computers.

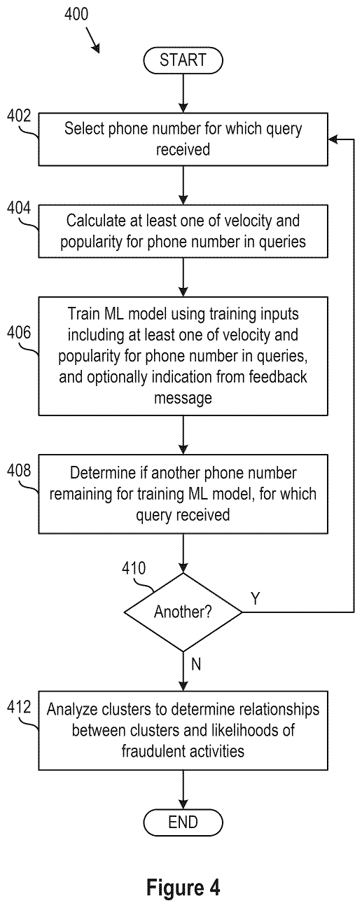

FIG. 4 is a flow diagram of a method 400 that may be performed by host computer 110 to train ML model 116 to help make predictions about the fraudulent use of phone numbers, according to some embodiments. Method 400 will be discussed as an example of implementing ML model 116 using a clustering algorithm such as density-based spatial clustering of applications with noise (DBSCAN) through unsupervised training. However, different implementations of ML model 116 are envisioned for other embodiments, including usage of different clustering algorithms.

At step 402, host computer 110 selects a phone number for which at least one query has been received from organization computers such as organization computer 130. A feedback message identifying whether the phone number has been used fraudulently, may or may not have been received by host computer 110. At step 404, host computer 110 calculates at least one of a velocity and popularity for the phone number in queries received from organization computers including organization computers 130, 140, and 150. For example, host computer 110 may calculate the velocity and/or popularity in the manner described above with respect to FIG. 3. Although the calculation of step 404 is illustrated as being performed after step 402, such calculation may be performed at another time. For example, each time a query is received including a phone number, the velocity and popularity for that phone number may be calculated (or recalculated) immediately.

At step 406, host computer 110 trains ML model 116 using training inputs including at least one of the calculated velocity and popularity for the phone number in queries. If host computer 110 is training ML model 116 to determine fraudulent activity based on velocity, host computer 110 uses training inputs including the calculated velocity. Additionally, or alternatively, if host computer 110 is training ML model 116 to determine fraudulent activity based on popularity, host computer 110 uses training inputs including the calculated popularity. The training by host computer 110 may optionally further include, as an additional training input, an indication from a feedback message about whether the phone number has been used fraudulently, which host computer 110 may read from memory 124 or storage 126 if such a feedback message has been received.

ML model 116 may also include additional training inputs such as those discussed above with respect to FIG. 3. For training inputs such as the indications, type(s) of queries, types of organizations, and reputations, host computer 110 may convert the training inputs into values. For example, host computer 110 may use 0 for an indication input if an indication has not been received by host computer 110, 1 if an indication has been received that the phone number has been used normally, and 2 if an indication has been received that the phone number has been used fraudulently. For example, ML model 116 may generate as an output, an assignment of a cluster to which the phone number belongs. For example, based on the DBSCAN algorithm, ML model 116 may generate the assignment in a manner that groups the phone number with other phone numbers that ML model 116 determines to be close based on the at least one of the velocity and the popularity, and on any other inputs being used for training ML model 116.

At step 408, host computer 110 determines whether there is another phone number remaining for training ML model 116, for which at least one query has been received from an organization computer. At step 410, if there is another of such phone numbers, method 400 returns to step 402, and host computer 110 selects the phone number for further training ML model 116. Otherwise, if there are no more of such phone numbers, method 400 moves to step 412.

At step 412, host computer 110 analyzes all the clusters generated by ML model 116 to determine relationships between the clusters and likelihoods of fraudulent activities. For example, for a cluster in which one or more phone numbers have been indicated in feedback messages as being used fraudulently, host computer 110 may determine that other phone numbers assigned to the cluster by ML model 116 are likely to have been used fraudulently at or above a threshold level. As another example, for a cluster in which all phone numbers for which feedback messages have been received, have been indicated by the feedback messages as being used normally, host computer 110 may determine that other phone numbers assigned to the cluster by ML model 116 are not likely to have been used fraudulently at or above a threshold level.

After step 412, method 400 ends. After performing method 400, host computer 110 may continuously train ML model 116 based on new queries and feedback messages received. For example, host computer 110 may repeat steps 402 to 406 each time a new query is received including a phone number or each time a new feedback message is received from an organization computer. Alternatively, for example, host computer 110 may periodically retrain ML model 116 by performing steps 402 to 406, e.g., every hour, based on batches of new queries and feedback messages.

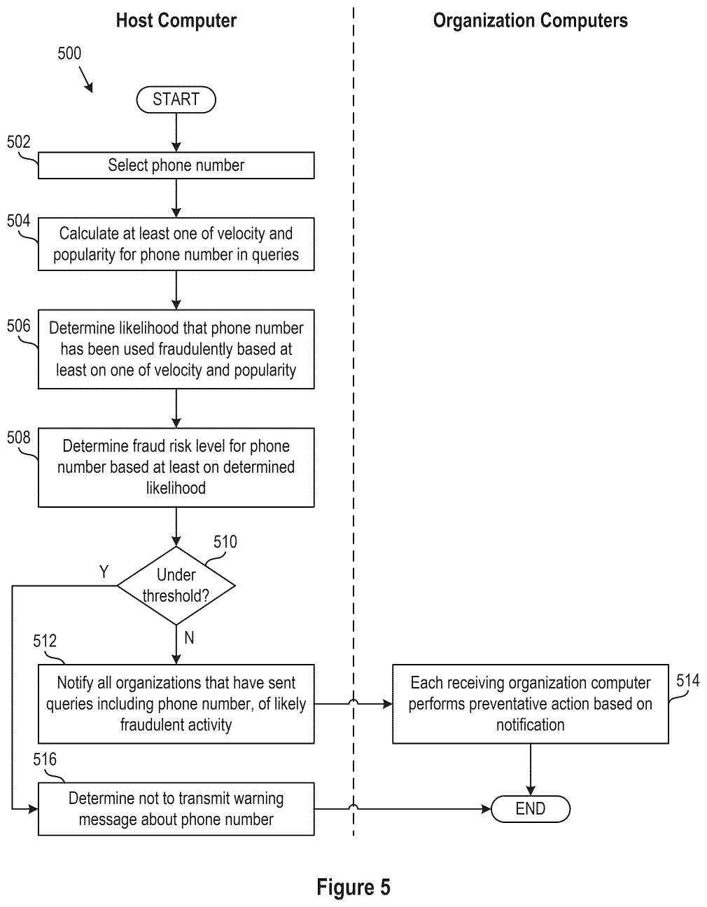

FIG. 5 is a flow diagram of a method 500 that may be performed by host computer 110 and organization computers such as organization computer 130, 140, and 150, to identify and respond to the fraudulent use of phone numbers, according to some embodiments. At step 502, host computer 110 selects a phone number. For example, the phone number may be one that was included in a query received by host computer 110 or in a feedback message received by host computer 110, in response to which host computer 110 has selected the phone number for analysis. At step 504, host computer 110 calculates at least one of a velocity and popularity for the phone number in queries received from organization computers including organization computers 130, 140, and 150. For example, host computer 110 may calculate the velocity and/or popularity in the manner described above with respect to FIG. 3.

At step 506, host computer 110 determines a likelihood that the phone number has been used fraudulently based at least on one of the calculated velocity and popularity. As just one example, if ML model 116 was trained according to method 300 of FIG. 3, host computer 110 may input at least one of the velocity and popularity of the phone number, along with other inputs used for training ML model 116. ML model 116 then generates a likelihood that the phone number has been used fraudulently, e.g., a value such as a percentage chance that the phone number has been used fraudulently or a category such as “low,” “medium,” “high,” or “very high.” As another example, if ML model 116 was trained according to method 400 of FIG. 4, host computer 110 may similarly input at least one of the velocity and popularity along with other inputs used for training ML model 116. ML model 116 then assigns the phone number to a cluster to group the phone number with other phone numbers that ML model 116 determines to be close based on the at least one of the velocity and the popularity, and any other inputs. Such cluster is associated with the determined likelihood that the phone number has been used fraudulently.

At step 508, host computer 110 determines a fraud risk level for the phone number based at least on the determined likelihood from step 506. As with the likelihood from step 506, the fraud risk level may be, e.g., a value such as a percentage chance that the phone number has been used fraudulently or a category such as “low,” “medium,” “high,” or “very high.” The fraud risk level may be based only on the likelihood determined from step 506. For example, if the likelihood determined at step 506 is a low percentage or a category such as “low,” then the fraud risk level may similarly be a low percentage or a category such as “low.” If the likelihood determined at step 506 is a high percentage or a category such as “very high,” then the fraud risk level may similarly be a high percentage or a category such as “very high.” On the other hand, the fraud risk level may be based on one or more additional factors.

For example, in addition to the likelihood determined at step 506, host computer 110 may determine whether suspicious behavior involving the phone number has occurred. For example, such suspicious behavior may be one or more of: the phone number having been transferred between SIM cards, a call-forwarding feature having been applied to the phone number, the phone number having been deactivated, and the phone number having been ported between cellular providers (especially if one of such behaviors occurred recently, e.g., less than a predetermined amount of time before a query including the phone number was received). As additional examples, such suspicious behavior may be one or more of: a related cellular account being a pre-paid account and/or having been activated recently, and a name and/or address associated with an account with an organization not matching a name and/or address of a person associated with the cellular account. As one example, even if the likelihood determined at step 506 is a low percentage or a category such as “low,” if one of the above suspicious behaviors involving the phone number has occurred, host computer 110 may determine that the fraud risk level is, e.g., a greater percentage or a category such as “medium” or “high.” As another example, even if the likelihood determined at step 506 is a high percentage or a category such as “very high,” if no suspicious behavior involving the phone number has occurred, host computer 110 may determine that the fraud risk level is, e.g., a lower percentage or a category such as “medium” or “high.”

At step 510, if the fraud risk level is not under a threshold (is at or above the threshold), method 500 moves to step 512. At step 512, host computer 110 notifies all organizations that have sent queries including the phone number at some point in time, of the likely fraudulent activity. Host computer 110 may transmit such notification to organization computers used by such organizations. Such notifications may be included in response to queries received from such organizations. Such notifications may also be independent messages separate from any of such queries, e.g., for organizations that sent queries including the phone number long ago such as more than a day ago. At step 514, each of such organization computers that received the notification performs a preventative action based on the notification. For example, each organization computer may transmit an instruction to a corresponding web server not to create an account based on the phone number, not to allow a requesting user computer to sign in to an account, or not to perform a transaction on behalf of a requesting user computer. After step 514, method 500 ends.

Returning to step 510, if the fraud risk level is under the threshold, method 500 moves to step 516. At step 516, host computer 110 determines not to transmit a warning message about the phone number. After step 516, method 500 ends. It should be noted that other notification methods are envisioned. For example, host computer 110 may notify organizations about the fraud risk level for a phone number regardless of the value or category, and organization computers may determine whether to perform preventative actions accordingly. For example, one of the organization computers such as organization computer 130 may determine to perform one of the preventative actions discussed above if such organization computer deems the fraud risk level determined and transmitted by host computer 110 to be sufficiently great.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

The embodiments described herein also relate to an apparatus for performing these operations. The apparatus may be specially constructed for required purposes, or the apparatus may be a general-purpose computer selectively activated or configured by a computer program stored in the computer. The embodiments described herein may also be practiced with computer system configurations including mobile computing devices, personal computers, server computers, microprocessor systems, mainframe computers, etc., and combinations thereof, which may communicate across one or more networks.

The embodiments described herein also relate to one or more computer programs or as one or more computer program modules embodied in computer-readable storage media. The term computer-readable medium refers to any data storage device that can store data, which can thereafter be input into an apparatus or computer system. Computer-readable media may be based on any existing or subsequently developed technology that embodies computer programs in a manner that enables a computer to read the programs. Examples of computer-readable media include magnetic drives, SSDs, network-attached storage (NAS) systems, RAM, read-only memory (ROM), compact disks (CDs), digital versatile disks (DVDs), and other optical and non-optical data storage devices. A computer-readable medium can also be distributed over a network-coupled computer system so that computer-readable code is stored and executed in a distributed fashion.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

As used herein, the phrase “at least one of” preceding a series of items with the term “and” or “or” to separate any of the items, modifies the list as a whole, rather than each member of the list (i.e., each item). The phrase “at least one of” does not require selection of at least one of each item listed. Rather, the phrase allows a meaning that includes at least one of any one of the items, and/or at least one of any combination of the items. By way of example, the phrases “at least one of A, B, and C” and “at least one of A, B, or C” each refers to only A, only B, only C, and/or any combination of A, B, and C. In any instances in which it is intended that a selection be of “at least one of each of A, B, and C,” or alternatively, “at least one of A, at least one of B, and at least one of C,” the selection is expressly described as such.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components may be implemented as a combined component. Similarly, structures and functionalities presented as a single component may be implemented as separate components. These and other variations, additions, and improvements may fall within the scope of the appended claims.

We claim:

1. A computer including a processor and memory, wherein the processor executes instructions stored in the memory to determine fraud risk levels for phone numbers, by performing the following steps:
continually monitoring a network connection for queries received from computers of a plurality of organizations, wherein each of the queries includes a phone number;
for each query received, extracting the phone number included in the query and storing the phone number extracted from the query in association with an identifier (ID) of an organization from which the query was received;
for each phone number extracted from the queries, determining a likelihood that the phone number has been used fraudulently, based at least on one of: (1) a frequency of the phone number being included in the queries, and (2) a number of different organizations that sent queries including the phone number; and
determining a fraud risk level for each phone number extracted from the queries based at least on the determined likelihood that the phone number has been used fraudulently, and transmitting a notification to one or more organizations when the fraud risk level of any of the phone numbers exceeds a threshold fraud risk.

2. The computer of claim 1, wherein the steps further include:
continually monitoring the network connection for feedback messages received from the computers of the organizations, wherein each of the feedback messages includes a phone number and an indication of whether the phone number has been used fraudulently;
for each feedback message received, extracting the phone number included in the feedback message and the indication included in the feedback message, and storing the phone number extracted from the feedback message in association with the indication extracted from the feedback message and an ID of the organization from which the feedback message was received; and
training a machine-learning (ML) model using, for each phone number extracted from one of the feedback messages, training inputs including at least one of (1) a frequency of the phone number being included in the queries, and (2) a number of different organizations that sent queries including the phone number, and also using an expected output based on the indication extracted from a feedback message including the phone number.

3. The computer of claim 2, wherein the steps further include:
for each phone number extracted from the queries, determining using the ML model, the likelihood that the phone number has been used fraudulently, by inputting at least one of (1) the frequency of the phone number being included in the queries, and (2) the number of different organizations that sent queries including the phone number, wherein the ML model then generates the likelihood that the phone number has been used fraudulently.

4. The computer of claim 1, wherein the steps further include:
continually monitoring the network connection for feedback messages received from the computers of the organizations, wherein each of the feedback messages includes a phone number and an indication of whether the phone number has been used fraudulently;
for each feedback message received, extracting the phone number included in the feedback message and the indication included in the feedback message, and storing the phone number extracted from the feedback message in association with the indication extracted from the feedback message and an ID of the organization from which the feedback message was received; and
training a machine-learning (ML) model using, for each phone number extracted from one of the feedback messages, training inputs including at least one of (1) a frequency of the phone number being included in the queries, and (2) a number of different organizations that sent queries including the phone number, and also including a training input based on the indication extracted from a feedback message including the phone number.

5. The computer of claim 4, wherein the steps further include:
for each phone number extracted from the queries, determining using the ML model, the likelihood that the phone number has been used fraudulently, by inputting at least one of (1) the frequency of the phone number being included in the queries and (2) the number of different organizations that sent queries including the phone number, wherein the ML model then assigns the phone number to a cluster associated with the likelihood that the phone number has been used fraudulently.

6. The computer of claim 1, wherein the steps further include:
for each phone number extracted from the queries, determining the likelihood that the phone number has been used fraudulently based at least on the number of different organizations that sent queries including the phone number.

7. A method of determining fraud risk levels for phone numbers, the method comprising:
continually monitoring a network connection for queries received from computers of a plurality of organizations, wherein each of the queries includes a phone number;
for each query received, extracting the phone number included in the query and storing the phone number extracted from the query in association with an identifier (ID) of an organization from which the query was received;
for each phone number extracted from the queries, determining a likelihood that the phone number has been used fraudulently, based at least on one of: (1) a frequency of the phone number being included in the queries, and (2) a number of different organizations that sent queries including the phone number; and
determining a fraud risk level for each phone number extracted from the queries based at least on the determined likelihood that the phone number has been used fraudulently, and transmitting a notification to one or more organizations when the fraud risk level of any of the phone numbers exceeds a threshold fraud risk.

8. The method of claim 7, further comprising:
continually monitoring the network connection for feedback messages received from the computers of the organizations, wherein each of the feedback messages includes a phone number and an indication of whether the phone number has been used fraudulently;
for each feedback message received, extracting the phone number included in the feedback message and the indication included in the feedback message, and storing the phone number extracted from the feedback message in association with the indication extracted from the feedback message and an ID of the organization from which the feedback message was received; and
training a machine-learning (ML) model using, for each phone number extracted from one of the feedback messages, training inputs including at least one of (1) a frequency of the phone number being included in the queries, and (2) a number of different organizations that sent queries including the phone number, and also using an expected output based on the indication extracted from a feedback message including the phone number.

9. The method of claim 7, wherein one of the queries includes an application programming interface (API) call requesting an indication of (1) whether a phone number included in the query has been transferred between subscriber identity module (SIM) cards, or (2) whether the phone number included the query was transferred between the SIM cards less than a predetermined amount of time before the query was received.

10. The method of claim 7, wherein one of the queries includes an application programming interface (API) call requesting an indication of whether a cellular account associated with a phone number included in the query (1) is a pre-paid account or (2) was activated for providing cellular services for the phone number included in the query less than a predetermined amount of time before the query was received.

11. The method of claim 7, wherein one of the queries includes an application programming interface (API) call requesting an indication of (1) whether a call-forwarding feature has been applied by a cellular provider to a phone number included in the query, or (2) whether the call-forwarding feature was applied to the phone number included in the query less than a predetermined amount of time before the query was received.

12. The method of claim 7, wherein one of the queries includes an application programming interface (API) call requesting an indication of (1) whether a phone number included in the query was previously deactivated by a cellular provider, or (2) whether the phone number included in the query was deactivated by the cellular provider less than a predetermined amount of time before the query was received.

13. The method of claim 7, wherein one of the queries includes an application programming interface (API) call requesting an indication of (1) whether a phone number included in the query has been ported between different cellular providers, or (2) whether the phone number included in the query was ported between the different cellular providers less than a predetermined amount of time before the query was received.

14. The method of claim 7, wherein one of the queries includes an application programming interface (API) call requesting (1) a name or address of a person associated with a cellular account for a phone number included in the query, or (2) an indication of whether a name or address included in the query matches a corresponding name or address for the person associated with the cellular account.

15. A non-transitory computer-readable medium comprising instructions that are executable in a computer, wherein the instructions when executed cause the computer to carry out a method of determining fraud risk levels for phone numbers, and wherein the method comprises:
continually monitoring a network connection for queries received from computers of a plurality of organizations, wherein each of the queries includes a phone number;
for each query received, extracting the phone number included in the query and storing the phone number extracted from the query in association with an identifier (ID) of an organization from which the query was received;
for each phone number extracted from the queries, determining a likelihood that the phone number has been used fraudulently, based at least on one of: (1) a frequency of the phone number being included in the queries, and (2) a number of different organizations that sent queries including the phone number; and
determining a fraud risk level for each phone number extracted from the queries based at least on the determined likelihood that the phone number has been used fraudulently, and transmitting a notification to one or more organizations when the fraud risk level of any of the phone numbers exceeds a threshold fraud risk.

16. The non-transitory computer-readable medium of claim 15, wherein the method further comprises:
continually monitoring the network connection for feedback messages received from the computers of the organizations, wherein each of the feedback messages includes a phone number and an indication of whether the phone number has been used fraudulently;
for each feedback message received, extracting the phone number included in the feedback message and the indication included in the feedback message, and storing the phone number extracted from the feedback message in association with the indication extracted from the feedback message and an ID of the organization from which the feedback message was received; and
training a machine-learning (ML) model using, for each phone number extracted from one of the feedback messages, training inputs including at least one of (1) a frequency of the phone number being included in the queries, and (2) a number of different organizations that sent queries including the phone number, and also using an expected output based on the indication extracted from a feedback message including the phone number.

17. The non-transitory computer-readable medium of claim 16, wherein the method further comprises:
for each phone number extracted from the queries, determining using the ML model, the likelihood that the phone number has been used fraudulently, by inputting at least one of (1) the frequency of the phone number being included in the queries, and (2) the number of different organizations that sent queries including the phone number, wherein the ML model then generates the likelihood that the phone number has been used fraudulently.

18. The non-transitory computer-readable medium of claim 15, wherein the method further comprises:
continually monitoring the network connection for feedback messages received from the computers of the organizations, wherein each of the feedback messages includes a phone number and an indication of whether the phone number has been used fraudulently;
for each feedback message received, extracting the phone number included in the feedback message and the indication included in the feedback message, and storing the phone number extracted from the feedback message in association with the indication extracted from the feedback message and an ID of the organization from which the feedback message was received; and
training a machine-learning (ML) model using, for each phone number extracted from one of the feedback messages, training inputs including at least one of (1) a frequency of the phone number being included in the queries, and (2) a number of different organizations that sent queries including the phone number, and also including a training input based on the indication extracted from a feedback message including the phone number.

19. The non-transitory computer-readable medium of claim 18, wherein the method further comprises:
for each phone number extracted from the queries, determining using the ML model, the likelihood that the phone number has been used fraudulently, by inputting at least one of (1) the frequency of the phone number being included in the queries and (2) the number of different organizations that sent queries including the phone number, wherein the ML model then assigns the phone number to a cluster associated with the likelihood that the phone number has been used fraudulently.

20. The non-transitory computer-readable medium of claim 15, wherein the method further comprises:
for each phone number extracted from the queries, determining the likelihood that the phone number has been used fraudulently based at least on the number of different organizations that sent queries including the phone number.
